(19) United States
(12) Patent Application Publication
(10) Pub. No.: US 2013/0297410 A1
(43) Pub. Date: Nov. 7, 2013

(54) SYSTEM AND METHOD FOR AUTIONING ADVERTISEMENT USING DIGITAL CONTENTS RANKING AND METHOD THEREFOR

(71) Applicant: Pulsus Technology Inc., Pohang-si (KR)

(72) Inventors: Jong Hoon OH, Seoul (KR); Joo Won LEE, Seoul (KR)

(21) Appl. No.: 13/938,897

(22) Filed: Jul. 10, 2013

Related U.S. Application Data
(63) Continuation of application No. PCT/KR2011/009899, filed on Dec. 21, 2011.

(30) Foreign Application Priority Data
Jan. 10, 2011 (KR) 10-2011-0002350

(51) Int. Cl. G06Q 30/02

(52) U.S. Cl. CPC G06Q 30/0275
USPC 705/14.45; 705/14.71

(57) ABSTRACT

The present invention relates to an auction for an advertisement that can be used for streaming of digital contents, and more specifically, to an auction for an advertisement that can be used for streaming of digital contents that can maximize the economic profit of a contents provider by maximizing the use of an advertisement. In particular, the present invention relates to a system and a method for conducting an advertisement auction considering popularity ranking of contents, specific contents, profile of users. The present invention enables a contents provider to use the characteristics of on-line contents to conduct the advertisement auction, thereby maximizing the economic profits, and building a foundation for maintaining a business that provides contents for free or at cost.

This is a Continuation of International Application No. PCT/KR2011/009899, filed Dec. 21, 2011.

### FIELD OF THE INVENTION

The present invention relates to an auction for an advertisement that can be used for streaming of digital contents, and more specifically, to an auction for an advertisement that can be used for streaming of digital contents that can maximize the economic profit of a contents provider by maximizing the use of an advertisement.

### BACKGROUND OF THE INVENTION

Recently, with the rapid development of the wired/wireless Internet, memory has a tendency of price reduction and rapid high capacity, and various digital players have appeared. The wired Internet is provided in the various forms of xDSL, a cable modem, an optic LAN, and FTTH (Fiber To The Home) and the wireless Internet is provided in the various forms of 4G, LTE, WiBro, WiFi, and the like beyond 2G or 3G, the speeds of which have reached several Mbps to several Gbps. Furthermore, various types of nonvolatile memory have been implemented in practice, and memory costs have been reduced to the extent that flash memory may substitute for a HDD (Hard Disk Drive). In addition, most cellular phones provide a function of reproducing digital contents such as MP3s and the like, and various digital players, such as MP3 players, PMPs (Portable Multimedia Players), smart phones, Tablet PCs, or e-Books, are on the market. Accordingly, from the point of view of the user, demands for various types of digital contents such as music, photos, moving pictures, multimedia, text, applications, games, or e-Books are on the increase.

In order to satisfy the demands of users for various types of contents, various contents providers have arisen and provide various types of contents services. In terms of cost, there are paid services or free-of-charge services. In the paid service, contents are provided when a user pays a fee for the contents, of which the iTunes service from Apple Inc is a representative example. In the free-of-charge service, an advertisement is exposed to a user for a predetermined time, and then contents with time or size corresponding to the advertisement are provided in the various forms of streaming. However, the contract between a contents provider and an advertiser does not reflect the characteristics of on-line contents in the related prior arts.

### DETAILED DESCRIPTION OF THE INVENTION

### Technical Problem

The present invention relates to an advertisement auction system and method between a contents provider and an advertiser, and provides a system and a method for conducting an advertisement auction in consideration of a popularity ranking of contents, a specific content, a user profiles and the like.

### Technical Solution

According to the first aspect of the present invention, there is provided a contents server comprising:

a database configured to store a plurality of contents, meta information and content popularity information related to the plurality of contents, user information, and a user profile related to the user information;

a control unit configured to provide a user with the contents stored in the database through streaming, and add advertisement to the streaming contents to provide the streaming contents with the advertisement; and

an advertisement auction management unit configured to receive bids from advertisers according to at least one of a contents ranking scheme, a specific contents scheme, and a user profile scheme, then to decide an advertiser for a content, and to store the decided advertisement information in the database.

According to the second aspect of the present invention, there is provided an advertisement auction method applied to streaming contents, comprising:

announcing, by a contents server, an advertisement auction condition for contents;

bidding, by an advertiser, in an advertisement auction for contents through the contents server; and

deciding an advertiser and an advertising condition for contents, and storing advertisement information and the advertisement condition in a database, by the contents server,

wherein the auction condition is characterized in conducting an advertisement auction according to at least one of popularity ranking of contents, a specific content, and a user profile.

According to the third aspect of the present invention, there is provided a contents server including:

a database configured to store a plurality of contents, meta information and content popularity information related to the plurality of contents, user information, a user profile related to the user information, and an advertisement condition decided through an auction; and

a control unit configured to provide a user with the contents stored in the database through streaming, and add advertisement to the streaming contents according to the advertisement condition to provide the streaming contents with the advertisement,

wherein the advertisement condition is characterized in conducting an advertisement according to at least one of a popularity ranking of contents, a specific content, and a user profile.

According to the fourth aspect of the present invention, there is provided a method for providing streaming contents including an advertisement decided through an auction, comprising:

receiving a contents streaming request from a user;

checking an advertisement condition for contents for which the contents streaming is requested;

putting advertisement corresponding to the advertisement condition into the requested contents; and

providing the contents including the advertisement to a user through streaming,

wherein the advertisement condition is characterized in advertising according to at least one of a popularity ranking of contents, a specific content, and a user profile.

### Advantageous Effects

According to the present invention, a contents provider is able to maximize economic profits by conducting an advertisement auction and utilizing the characteristics of on-line contents, and establish a base capable of maintaining a business for providing a paid content service or a free-of-charge content service.

An advertiser is able to freely conduct an advertisement by reflecting a popularity ranking of contents, a specific content, a user profile and the like, thereby maximizing the effect of the advertisement.

Furthermore, a user views or listens to an advertisement for a short time during which on-line contents are streamed and downloaded, thereby enjoying the contents free-of-charge or at a low cost.

### BRIEF DESCRIPTION OF DRAWINGS

FIG. 1 is a diagram illustrating the configuration of an advertisement auction system in accordance with the present invention.

FIG. 2 is a diagram illustrating the configuration of a contents server in accordance with an embodiment of the present invention.

FIG. 3 is a diagram illustrating an advertisement auction method applied to contents in accordance with an embodiment of the present invention.

### EMBODIMENTS OF THE INVENTION

Hereinafter, exemplary embodiments of the present invention will be described in detail with reference to the accompanying drawings. The configuration and operation effects of the present invention will be clearly understood from the following detailed description.

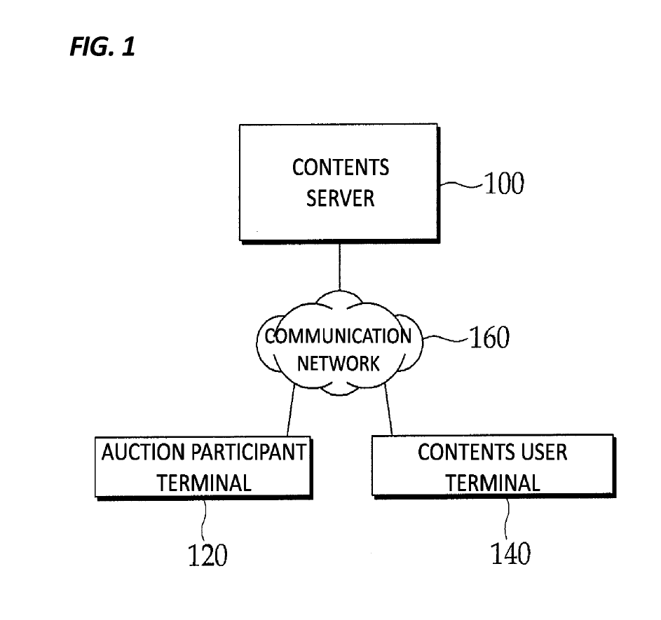

FIG. 1 is a diagram illustrating the configuration of an advertisement auction system in accordance with the present invention.

Referring to FIG. 1, a contents provider operates a contents server 100 that provides various types of contents through a paid service or a free-of-charge service. The contents include various types of music, photos, moving pictures, multimedia, text and the like, which are normally compressed using various codec algorithms depending on the amount of data and are provided to users in that form. Users restore it using corresponding algorithms in order to reproduce the contents. A communication network 160, which connects the contents server 100, an auction participant terminal 120, and a contents user terminal 140 to one another, includes a wired network and a wireless network. The wired Internet includes various schemes and media such as xDSL, a cable modem, an optic LAN, and FTTH (Fiber To The Home), and the wireless Internet includes various schemes and media such as 2G, 3G, 4G, LTE, WiBro, WiFi, and the like.

The auction participant terminal 120 is used so that an auction participant bids in an auction for contents, and includes various types of terminals such as computers, cellular phones, smart phones, tablet PCs, and the like.

The contents user terminal 140 is used so that a contents user receives a contents service and advertisement provided by the contents server 100, and includes various types of terminals such as computers, cellular phones, smart phones, tablet PCs, and the like.

The contents server 100 announces advertisement auction conditions for contents, and auction participants bid on the advertisement for the contents through the auction participant terminal 120. One of the auction bidders is finally decided as the advertiser, and thus advertising provided by the advertiser is provided during a contents service. That is, when contents users access the contents server 100 through the contents user terminal 140 and receive contents, the advertisement applied to the contents is delivered.

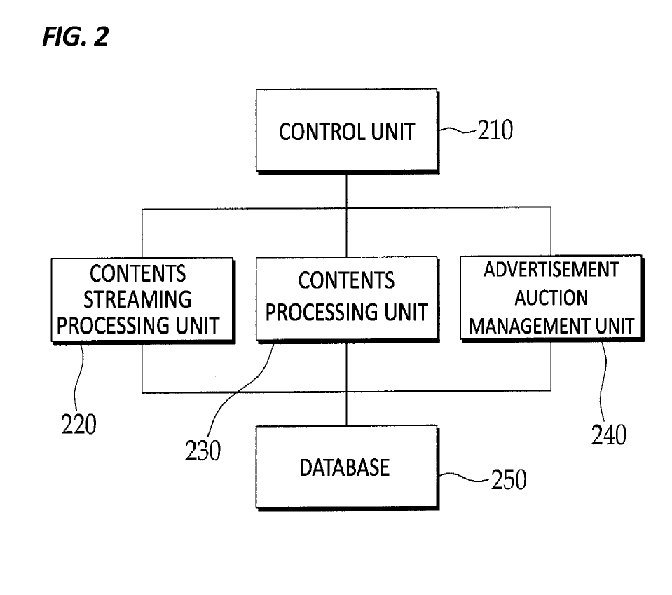

FIG. 2 is a diagram illustrating the internal configuration of the contents server 100 in accordance with the present invention.

Referring to FIG. 2, the contents server 100 may include a control unit 210, a contents streaming process unit 220, a contents processing unit 230, an advertisement auction management unit 240, a database 250, and the like.

When a contents user logs in the contents server 100 to request and stream various types of contents, in response, the contents streaming process unit 220 streams contents and added advertisement to the users.

The contents processing unit 230 adds and processes an advertisement suitable for advertisement conditions to contents requested by the users. When the advertisement condition is a contents popularity ranking scheme, the contents processing unit 230 recognizes the current popularity ranking of the contents requested by the users through the database 250, and processes an advertisement of an advertiser for the corresponding ranked contents to be provided to the users, either before or in the middle of contents streaming.

The advertisement auction management unit 240 performs the entire process related to the advertisement auction. That is, the advertisement auction management unit 240 announces advertisement auction-related items, accepts bids from auction participants, decides an advertiser based on the bidding, and stores the decision result in the database 250.

The control unit 210 manages and controls the entire function of the contents server 100. The control unit 210 performs work such as a contents streaming service, an advertisement auction process, an advertisement streaming service, user management, and the like in association with the contents streaming process unit 220, the contents processing unit 230, the advertisement auction management unit 240, the database 250, and the like.

The database 250 includes a contents database (contents DB), an advertisement DB, a user DB, and the like. The contents DB stores various contents to be provided to users, and stores supplementary data, meta data, and the like associated with the contents.

The meta data includes a genre, a release year, the title of a song, a singer, an album name, a songwriter, a lyricist and the like, and representatively includes ID3 TAGs used in MP3 music files. The supplementary data includes this week's popularity ranking, the current popularity ranking, a popularity ranking history including last week's popularity ranking or a past popularity ranking, a popularity distribution according to user profiles, and the like. Such meta data and supplementary data may be utilized in advertisement auction.

The advertisement DB stores various types of compressed advertisement data such as audio, video, text, multimedia and the like, and supplementary data related to the compressed advertisement data. The supplementary data includes advertiser information related to the advertisement data, as well as information on advertising contract conditions and details, the contract term, and the like.

The user DB stores account-related information such as an ID and a password of a user, and supplementary data, such as a gender, a region, musical favorites, a job, or the academic background of a user, which is used to characterize and classify users, i.e., user profiles.

The advertisement contract conditions include a contents ranking scheme, a contents-based scheme, a scheme using user profiles, and a combination thereof. First of all, in the case of an advertisement contract employing the contents ranking scheme, the advertisement is implemented according to the current popularity ranking of contents. That is, the advertisement for first-and-second-ranked contents is implemented as advertising for a company A, and the advertisement for third-ranked contents is implemented as advertising for a company B. In the case of the auction of this scheme, since highly popularity-ranked contents are frequently provided to users, the bidding price of an advertiser increases in proportion to the ranking, and thus advertising profits of the contents provider are maximized.

In the case of an advertisement contract employing the contents-based scheme, an advertisement is implemented according to contents such as a specific song, movie, drama, and the like. For example, the song “Always” sung by Huhgak is provided in the various forms of an advertisement for a company A, and the song “Hoot” sung by Girls' Generation, is provided in the various forms of an advertisement for a company B. In the case of the auction of this scheme, since the probability of bidding on advertisement having a high association with a user enjoying specific contents is high, and the bidding price of an advertiser increases in proportion to the probability of bidding, and thus the advertising profits of the contents provider are maximized.

In the case of an advertisement contract employing the scheme using the user profiles, various types of advertisement are implemented according to user profiles. That is, an advertisement for a company A is provided to a female user living in Seoul and an advertisement for a company B is provided to a man in his 40s. In the case of the auction of this scheme, since an advertiser is able to provide an advertisement focusing on a user group that is the target of marketing for the products and services advertised by the advertiser, the bidding price of the advertiser is expected to be high, and thus the advertising profits of the contents provider are maximized.

Furthermore, it is possible to utilize a combination of the aforementioned advertisement contract conditions. For example, in the case of an advertisement contract employing a combination of the contents ranking scheme and the scheme using user profiles, an advertisement for a company A is provided to teens and people in their 20s, and an advertisement for a company B is provided to people in their 30s and 40s among users who listen to first-and-second-ranked contents. This example explains a combination scheme (a first scheme) in which two advertisement contract conditions are simultaneously combined with each other.

According to another combination, an advertisement contract employing the contents ranking scheme is implemented for a predetermined period, and an advertisement contract employing the contents-based scheme is implemented for a subsequent predetermined period. For example, an advertisement contract may be implemented in a manner such that advertisement is provided to users who listen to first-and-second-popularity-ranked songs for two weeks, and advertisement is provided to users who listen to a specific song, such as “Hoot” sung by Girls' Generation, for the next four weeks. This example corresponds to a combination scheme (a second scheme) in which two advertisement contract conditions are sequentially combined with each other.

The embodiment describes, as an example, the combination scheme in which the contents ranking and the user profiles are simultaneously combined with each other, and the combination scheme in which the contents ranking and the contents-based scheme are sequentially combined with each other. However, the present invention is not limited thereto. Two or more different advertisement contract conditions may be combined with one another according to the first scheme or the second scheme, or may be utilized by combining the first scheme with the second scheme.

Furthermore, an advertisement may be provided before contents streaming or in the middle of the contents streaming, and may be provided once or a plurality of times. In addition, advertising time may be set as a predetermined time, or may be set in consideration of variables such as the traffic situation of the Internet, user profiles, and the like.

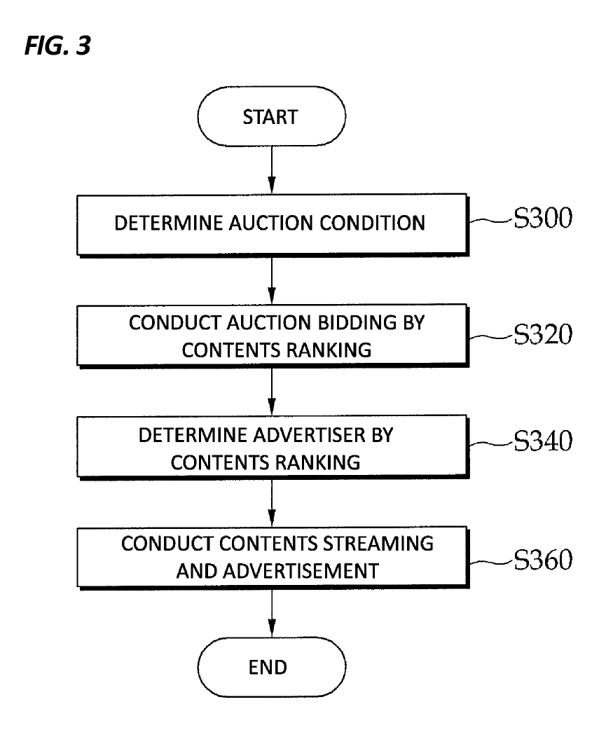

FIG. 3 is a diagram illustrating an advertisement auction method in accordance with the embodiment of the present invention.

Referring FIG. 3, an advertisement auction method employing the contents ranking scheme includes an auction condition decision step (S300), an auction bidding step (S320) according to contents ranking, an advertiser decision step (S340) according to contents ranking, and a contents streaming and advertisement implementation step (S360).

In the auction condition decision step (S300), a contents provider decides whether to set an advertisement auction condition as the contents ranking scheme, and a detailed auction method. That is, an auction may be conducted individually according to the popularity ranking of contents, or may also be conducted in a manner of blanket auction combining two to five popularity ranking. Furthermore, a minimum auction price may be set in advance according to necessity.

In addition, it may be possible to make a combination with auction conditions employing other schemes. For example, in the case of an advertisement contract employing a combination of the contents ranking scheme and the scheme using user profiles, an advertisement for a company A is provided to teens and people in their 20s, and an advertisement for a company B is provided to people in their 30s and 40s among users who listen to first-and-second-ranked contents.

According to another combination, an advertisement contract employing the contents ranking scheme may be implemented for a predetermined period, and an advertisement contract employing the contents-based scheme may be made for a subsequent predetermined period. For example, an advertisement contract may be made in such a manner that an advertisement is provided to users who listen to first-and-second-popularity-ranked songs for two weeks, and an advertisement is provided to users who listen to a specific song, such as “Hoot” sung by Girls' Generation, for the next four weeks.

In the auction bidding step (S320) according to contents ranking, auction-related main items decided in the auction condition decision step (S300) are announced to advertisers, and the advertisers bid in the auction.

The items to be announced may include items regarding an auction scheme (the contents ranking scheme or a combination with other schemes), a blanket auction, the number (2 to 5) of content items to be auctioned simultaneously, a contract term, a minimum auction price, the winning bidder decision criteria, an auction schedule and the like, and among these items, selected items only may be announced. The winning bidder decision criteria may include a maximum bid ranking, or another factor considered to be important by the contents provider, for example, a long term business relationship or advertiser conditions.

In the advertiser decision step (S340) according to contents ranking, the contents provider collects bids from advertisers and decides final advertisers who satisfy the winning bidder decision criteria.

In the contents streaming and advertisement implementation step (S360), the contents provider receives a contract amount from the decided advertisers, makes a contract, and implements advertising according to the contract.

The contents server 100 may provide an advertisement according to the advertisement condition, that is, the contents ranking scheme or a combination with other schemes, when streaming contents to users by utilizing the contents DB, the advertisement DB, the user DB and the like within the contents server.

The entire process may be performed by the contents server 100. However, the entire process may also be automatically performed through a similar Internet server (that is, a separate advertisement auction server) in the various forms of a program.

The disclosed embodiment should be considered not meant to limit the present invention. The scope of the present invention is determined by the appended claims and all differences within a range equivalent thereto should be construed as being included in the present invention.

1. A contents server comprising:
a database configured to store a plurality of contents, meta information and content popularity information related to the plurality of contents, user information, and a user profile related to the user information;
a control unit configured to provide a user with the contents stored in the database through streaming, and add advertisement to the streaming contents to provide the streaming contents with the advertisement; and
an advertisement auction management unit configured to receive bids from advertisers according to at least one of a contents ranking scheme, a specific contents scheme, and a user profile scheme, then to decide an advertiser for a content, and to store the decided advertisement information in the database.

2. The contents server according to claim 1, wherein, in the contents ranking scheme, an advertisement auction is conducted for popularity ranking of contents such that advertisement is provided at a time of streaming of contents corresponding to a popularity ranking selected by an advertiser.

3. The contents server according to claim 1, wherein in the specific contents scheme, an advertisement auction is conducted according to contents such that advertisement is provided at a time of streaming of specific contents selected by an advertiser.

4. The contents server according to claim 1, wherein in the user profile scheme, an advertisement auction is conducted for a specific classification of a user such that an advertisement is provided when a user of a specific group selected by an advertiser requests contents streaming.

5. The contents server according to claim 4, wherein the user profile includes one of a gender, a region, musical favorites, a job, or an academic background of a user.

6. An advertisement auction method applied to streaming contents, comprising:
announcing, by a contents server, an advertisement auction condition for contents;
bidding, by an advertiser, in an advertisement auction for contents through the contents server; and
deciding an advertiser and an advertising condition for contents, and storing advertisement information and the advertisement condition in a database, by the contents server,
wherein the auction condition is characterized in conducting an advertisement auction according to at least one of popularity ranking of contents, a specific content, and a user profile.

7. The advertising auction method according to claim 6, wherein the advertisement auction is conducted by a first scheme in which two or more of the popularity ranking of contents, the specific content, and the user profile are simultaneously combined with one another, or a second scheme in which two or more of the popularity ranking of contents, the specific content, and the user profile are sequentially combined with one another.

8. The advertisement auction method according to claim 7, wherein the advertisement auction is conducted in combined manner of the first scheme and the second scheme.

9. A contents server comprising:
a database configured to store a plurality of contents, meta information and content popularity information related to the plurality of contents, user information, a user profile related to the user information, and an advertisement condition decided through an auction; and
a control unit configured to provide a user with the contents stored in the database through streaming, and add advertisement to the streaming contents according to the advertisement condition to provide the streaming contents with the advertisement,
wherein the advertisement condition is characterized in conducting an advertisement according to at least one of a popularity ranking of contents, a specific content, and a user profile.

10. The contents server according to claim 9, wherein the advertisement condition is characterized in advertising according to one of the popularity ranking of contents, the specific content, and the user profile for a predetermined period, and advertising according to another one of the popularity ranking of contents, the specific content, and the user profile after the predetermined period.

11. The contents server according to claim 9, wherein the advertisement condition is characterized in advertising in simultaneously combined manner of one and another of the popularity ranking of contents, the specific content, and the user profile.

12. A method for providing streaming contents including an advertisement decided through an auction, comprising:
receiving a contents streaming request from a user;
checking an advertisement condition for contents for which the contents streaming is requested;
putting advertisement corresponding to the advertisement condition into the requested contents; and
providing the contents including the advertisement to a user through streaming,
wherein the advertisement condition is characterized in advertising according to at least one of a popularity ranking of contents, a specific content, and a user profile.

13. The method according to claim 12, wherein the advertisement condition is characterized in advertising according to one of the popularity ranking of contents, the specific content, and the user profile for a predetermined period, and advertising according to another one of the popularity ranking of contents, the specific content, and the user profile after the predetermined period.

14. The method according to claim 12, wherein the advertisement condition is characterized in advertising in simultaneously combined manner of one and another of the popularity ranking of contents, the specific content, and the user profile.
